(19) United States
(12) Patent Application Publication
(10) Pub. No.: US 2004/0167268 A1
(43) Pub. Date: Aug. 26, 2004

(54) Impact-strength-modified polymer compositions

(76) Inventors: Marc Vathauer, Koln (DE); Gerwolf Quaas, Koln (DE); Andreas Seidel, Dormagen (DE)

Correspondence Address: BAYER POLYMERS LLC, 100 BAYER ROAD, PITTSBURGH, PA, 15205, US

(21) Appl. No.: 10/719,720

(22) Filed: Nov. 21, 2003

(30) Foreign Application Priority Data
Nov. 25, 2002 (DE) 10254877.3
Dec. 6, 2002 (DE) 10257077.9

(51) Int. Cl. C08K 3/34; C08K 3/04

(52) U.S. Cl. 524/445; 524/495

(57) ABSTRACT

A conductive, impact-strength-modified polyamide molding composition is disclosed. The composition contains A) 40 to 99 parts by weight polyamide, B) 0.5 to 50 parts by weight graft polymer, C) 0.1 to 30 parts by weight mineral in particulate form, D) 0 to 1.5 parts by weight electrically conductive carbon particles, E) 0.1 to 15 parts by weight of at least one member selected from the group consisting of polyester ether amide, polyester/ether block copolymer and polyamide/polyester block copolymer. Embodiments that further contain any of compatibility promoter, vinyl (co)polymer, phenolformaldehyde resin and polymer additive are also disclosed. The composition is particularly suitable for online lacquering.

### FIELD OF THE INVENTION

The invention relates to molding compositions and more particularly to thermoplastic, impact-strength-modified polyamide compositions.

### SUMMARY OF THE INVENTION

A conductive, impact-strength-modified polyamide molding composition is disclosed. The composition contains A) 40 to 99 parts by weight polyamide, B) 0.5 to 50 parts by weight graft polymer, C) 0.1 to 30 parts by weight mineral in particulate form, D) 0 to 1.5 parts by weight electrically conductive carbon particles, E) 0.1 to 15 parts by weight of at least one member selected from the group consisting of polyester ether amide, polyester/ether block copolymer and polyamide/polyester block copolymer. Embodiments that further contain any of compatibility promoter, vinyl (co)polymer, phenolformaldehyde resin and polymer additive are also disclosed. The composition is particularly suitable for online lacquering.

### TECHNOLOGICAL BACKGROUND

DE-A 101 019 225 describes generally polymer compositions containing polyamide, graft polymer, vinyl (co)polymer, compatibility promoter and ultrafine mineral particles with anisotropic particle geometry. In DE-A 101 019 225 it is not mentioned that the compositions described therein may be lacquered online.

Polymer blends consisting of a polyamide, a styrene/acrylonitrile copolymer and a compatibility promoter are known from EP 0 202 214 A. A copolymer formed from a vinyl aromatic monomer and acrylonitrile, methacrylonitrile, C₁ to C₄ alkyl methacrylate or C₁ to C₄ alkyl acrylate in a weight ratio from 85:15 to 15:85 is employed by way of compatibility promoter. Through the use of compatibility promoters, an enhanced impact strength is to be obtained. A disadvantage of the polymer blends described in this printed publication is that they exhibit too low a stiffness and too high a coefficient of expansion for thin-wall applications.

From JP 11 241 016.A2 polyamide molding compositions are known that contain, in addition to polyamide, rubber-modified styrene polymers, graft polymers based on ethylene/propylene rubbers and talc with a particle diameter from 1 μM to 4 μm.

EP-A 0 718 350 describes polymer blends consisting of a crystalline and an amorphous or semicrystalline polymer and also 2 to 7 wt. % electrically conductive carbon (carbon black) for the production of molded, thermoplastic objects which are lacquered electrostatically in a further step. Particularly highly thermostable polymer blends with a conductive finish are not described in this document.

Thermoplastic and elastomeric antistatically finished compositions are described in U.S. Pat. No. 5,965,206. The antistatic agents consist of polyethers, polyesters, polyester ether amides, polyether esters or mixtures and copolymers formed from these substances and also an organic or inorganic salt. A large number of polymers are listed as thermoplastic and elastomeric polymers. The compositions of the present invention, however, are not described. Furthermore, antistatic compositions consisting of polyether ester amides and polyether esters are described in WO 02/055411 and EP-A 613 919.

Generally known, furthermore, is the use of fine-particle inorganic materials in certain polymer compositions, particularly in polycarbonate compositions. The inorganic materials are employed in these compositions, for example, as reinforcing material for the purpose of increasing the stiffness and tensile strength, for the purpose of enhancing the dimensional stability in the event of fluctuations in temperature, for the purpose of improving the surface properties or—in flame-resistant materials—also as flameproofing synergist. Use is made both of mineral materials and of synthetically prepared materials. Thus in U.S. Pat. No. 5,714,537, for example, polycarbonate blends are described which contain certain inorganic fillers for the purpose of improving the stiffness and resistance to linear thermal expansion.

Impact-strength-modified polyethylene-terephthalate/polycarbonate blends that which are suitable for online lacquering are known from WO 01/34703. Polyamide blends are not described.

Known for some directly lacquerable online/inline applications is Noryl® GTX, produced by General Electric Plastics (cf. EP-A 685 527) a blend containing polyamide and polyphenylene ether (PA/PPO blend).

As a rule, exterior bodywork parts made of plastics have to be lacquered. In the case of plastics that have been stained the color of the car, the bodywork add-on parts produced therefrom are, as a rule, covered with one or more layers of transparent lacquer. In the case of plastics that have not been stained the color of the car, the bodywork add-on parts produced therefrom are lacquered with several layers of lacquer, whereby at least one of the layers is color-imparting (coating lacquer). Depending on the thermostability of the plastics, a distinction is made here between various processes which differ in the time of attachment of the plastic add-on parts to the exterior bodywork part. If the plastic add-on parts go through the entire lacquering process, one generally speaks of an “online” lacquering, which makes the greatest demand on the thermostability of the plastic. In the case of so-called “inline” lacquering, the-plastic-add-on part is mounted onto the exterior bodywork part and introduced into the lacquering line after the so-called cathodic dipping. In the case of so-called “offline” lacquering, the entire plastic add-on part is lacquered outside the lacquering line at low temperatures and is only subsequently mounted onto the exterior bodywork part.

The online process is preferred by the automobile industry, since it minimises the working steps, and, besides, the best color matching of plastic and sheet metal is obtained. With this process, temperatures of up to 205° C. are attained, so great demands are made on the thermostability of the molding.

If it is possible to modify a plastic in such a way that its specific resistivity becomes so low that it may be used in the electrostatic lacquering without previous treatment with a conductive primer system, one production step is bypassed.

Additional demands which are made on the bodywork add-on parts made of plastic are good stiffness, low thermal expansion and aftershrinkage, good surface quality, good lacquerability and good resistance to chemicals. In addition, the molding compositions that are used for producing the exterior bodywork parts must exhibit good flowability in the molten state.

It was the object of the present invention to make available polyamide molding compositions with reduced specific resistivity that exhibit a combination of properties of good thermostability, impact resistance and increased elongation at rupture with, at the same time, good processing behaviour.

### DETAILED DESCRIPTION OF THE INVENTION

The object was achieved by a polymer composition containing

(A) 40-99, preferably 45-95, particularly preferably 50-85, in particular 50 to 80 parts by weight polyamide

(B) 0.5-50, preferably 1-40, particularly preferably 1-30, in particular 5 to 25 parts by weight graft polymer

(C) 0.1-30, preferably 1-20, particularly preferably 2-15, in particular 4-13 parts by weight mineral particles

(D) 0-1.5 parts by weight electrically conductive carbon particles

(E) 0.1-15, preferably 1-12, particularly preferably 2-10 parts by weight containing at least one polymer selected from the group comprising the polyester ether amides, polyester/ether block copolymers, polyamide/polyether block copolymers.

The composition may contain as further components compatibility promoter (component F) and/or vinyl (co)polymer (component G), phenolformaldehyde resin (H) and conventional polymer additives (J).

The invention also provides, moreover, the online-lacquered moldings that may be obtained from the aforementioned compositions.

It has been found that a plastic with the above composition displays excellent thermostability and that, by reason of the latter, use in online lacquering processes is well possible. In addition, said plastic exhibits a Class-A surface, high stiffness and outstanding resistance to chemicals.

Moreover, it has been found that the combination of conductive carbon blacks with at least one polymer selected from polyester ether amides and polyether/ester block copolymers are well suited for the conductive finish.

The components of the polymer composition that are suitable in accordance with the invention are elucidated in exemplary manner below.

Component A

Polyamides (component A) that are suitable in accordance with the invention are known or may be prepared by processes known from the literature. Polyamides that are suitable in accordance with the invention are known homopolyamides, copolyamides and mixtures of these polyamides. These may be partially crystalline and/or amorphous polyamides. Suitable as partially crystalline polyamides are polyamide 6, polyamide 66, mixtures and corresponding copolymers formed from these components. Moreover, partially crystalline polyamides enter into consideration, the acid component of which consists entirely or partially of terephthalic acid and/or isophthalic acid and/or suberic acid and/or sebacic acid and/or azelaic acid and/or adipic acid and/or cyclohexanedicarboxylic acid and the diamine component of which consists entirely or partially of m- and/or p-xylylenediamine and/or hexamethylenediamine and/or 2,2,4-trimethylhexamethylenediamine and/or 2,4,4-trimethylhexamethyl-enediamine and/or isophoronediamine and the composition of which is known in principle.

In addition suitable polyamides that are prepared entirely or partially from lactams with 7 to 12 carbon atoms in the ring, optionally with concomitant use of one or more of the aforementioned initial components.

Particularly preferred partially crystalline polyamides are polyamide 6 and polyamide 66 and their mixtures. Known products may be employed by way of amorphous polyamides. They are obtained by polycondensation of diamines such, as ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclohexyl)propane, 3,3′-dimethyl-4,4′-diaminodicyclohexylmethane, 3-aminomethyl-3,5,5-trimethylcyclohexylamine, 2,5- and/or 2,6-bis(aminomethyl)norbornane and/or 1,4-diaminomethylcyclhexane with dicarboxylic acids such as oxalic acid, adipic acid, azelaic acid, decanedi-carboxylic acid, heptadecanedicarboxylic acid, 2,2,4- and/or 2,4,4-trimethyladipic acid, isophthalic acid and terephthalic acid.

Also suitable are copolymers that are obtained by polycondensation of several monomers; furthermore copolymers that are prepared by addition of aminocarboxylic acids such as ε-aminocaproic acid, ω-aminoundecanoic acid or ω-aminolauric acid or their lactams.

Particularly suitable amorphous polyamides are the polyamides prepared from isophthalic acid, hexamethylenediamine and other diamines such as 4,4-diaminodicyclohexylmethane, isophoronediamine, 2,2,4- and/or 2,4,4-trimethylhexamethylenediamine, 2,5- and/or 2,6-bis(aminomethyl)norbornene; or from isophthalic acid, 4,4′-diaminodicyclohexylmethane and ε-caprolactam; or from isophthalic acid, 3,3′-dimethyl-4,4′-diaminodicyclohexylmethane and laurolactam; or from terephthalic acid and the isomer mixture of 2,2,4- and/or 2,4,4-trimethylhexamethylenediamine.

Instead of the pure 4,4′-diaminodicyclohexylmethane, mixtures of the positional isomers diaminodicyclohexylmethanes may also be employed that are composed of

70 to 99 mol % of the 4,4′-diamino isomer,

1 to 30 mol % of the 2,4′-diamino isomer and

0 to 2 mol % of the 2,2′-diamino isomer,

optionally corresponding to more highly condensed diamines that are obtained by hydrogenation of diaminodiphenylmethane of technical quality. The isophthalic acid may be replaced by terephthalic acid in a proportion amounting to up to 30%.

The polyamides preferably exhibit a relative viscosity (measured in respect of a 1 wt. % solution in m-cresol at 25° C.) from 2.0 to 5.0, particularly preferably from 2.5 to 4.0.

The polyamides may be contained in component A as a single resin or as a mixture of several polyamides.

Component B

Component B comprises one or more rubber-modified graft polymers. The rubber-modified graft polymer B comprises a random (co)polymer formed from vinyl monomers B.1, preferably according to B.1.1 and B.1.2, and also a rubber B.1.2 that has been grafted with vinyl monomers, preferably according to B.1.1 and B.1.2. Preparation of B is effected in known manner by radical polymerisation, for example in accordance with an emulsion, bulk or solution or bulk-suspension polymerisation process, as described, for example, in U.S. Pat. No. 3,243,481, U.S. Pat. No. 3,509,237, U.S. Pat. No. 3,660,535, U.S. Pat. No. 4,221,833 and U.S. Pat. No. 4,239,863. Particularly suitable graft rubbers are also ABS polymers that are obtainable by redox initiation with an initiator system consisting of organic hydroperoxide and ascorbic acid according to U.S. Pat. No. 4,937,285.

Preferred are one or more graft polymers of 5 to 95, preferably 20 to 90 wt. % of at least one vinyl monomer B.1 on 95 to 5, preferably 80 to 10 wt. % of one or more graft bases B.2 with glass transition temperatures <10° .C, preferably <−10° C.

Preferred monomers B.1.1 are styrene, α-methylstyrene, halogen-substituted or alkyl-ring-substituted styrenes such as p-methylstyrene, p-chlorostyrene, (meth)acrylic C₁-C₈ alkyl esters such as methyl methacrylate, n-butyl acrylate and tert-butyl acrylate. Preferred monomers B.1.2 are unsaturated nitriles such as acrylonitrile, methacrylonitrile, (meth)acrylic C₁-C₈ alkyl ester such as methyl methacrylate, n-butyl acrylate, tert-butyl acrylate, derivatives (such as anhydrides and imides) of unsaturated carboxylic acids such as maleic anhydride and N-phenylmaleimide or mixtures thereof.

Particularly preferred monomers B.1.1 are styrene, α-methylstyrene and/or methyl methacrylate; particularly preferred monomers B.1.2 are acrylonitrile, maleic anhydride and/or methyl methacrylate.

Patricularly preferred monomers are B1.1 styrene and B1.2 acrylonitrile

Suitable rubbers B.2 for the rubber-modified graft polymers B are, for example, diene rubbers, acrylate rubbers, polyurethane rubbers, silicone rubbers, chloroprene rubbers and ethylene/vinyl-acetate rubbers. Composites formed from various of the stated rubbers are also suitable as graft bases.

Preferred rubbers B.2 are diene rubbers (for example, based on butadiene, isoprene etc.) or mixtures of diene rubbers or copolymers of diene rubbers or mixtures thereof with other copolymerisable vinyl monomers (e.g. according to B.1.1 and B.1.2), with the proviso that the glass transition temperature of component B.2 lies below 10° C., preferably below −10° C. Particularly preferred is pure polybutadiene rubber. Other copolymerizable monomers may be contained in the rubber base in a proportion up to 50 wt. %, preferably up to 30 wt. %, in particular up to 20 wt. % (relative to the rubber base B.2).

Suitable acrylate rubbers according to B.2 of the polymers B are preferably polymers formed from acrylic alkyl esters, optionally with up to 40 wt. %, relative to B.2, other polymerizable, ethylenically unsaturated monomers. The preferred polymerizable acrylic esters include C₁ to C₈ alkyl esters, for example methyl, ethyl, butyl, n-octyl and 2-ethylhexyl esters; halogen alkyl esters, preferably halogen C₁-C₈ alkyl esters, such as chloroethyl acrylate and also mixtures of these monomers.

Preferred “other” polymerizable, ethylenically unsaturated monomers, which in addition to the acrylic esters may optionally serve for preparing the graft base B.2, are, for example, acrylonitrile, styrene, α-methylstyrene, acrylamides, vinyl C₁-C₆ alkyl ethers, methyl methacrylate, butadiene. Preferred acrylate rubbers by way of graft base B.2 are emulsion polymers that have a gel content of at least 60 wt. %.

Further suitable graft bases according to B.2 are silicone rubbers with graft-active points, as described in DE-A 3 704 657, DE-A 3 704 655, DE-A 3 631 540 and DE-A 3 631 539.

Particularly preferred graft polymers according to the present invention do not have a graft base based on ethylene/propylene rubbers (EPR) or on rubbers based on ethylene/propylene and on non-conjugated diene (EPDM). Such EPR or EPDM rubber based graft polymers are disclosed e.g. in JP 11241016A2.

The gel content of the graft base B.2 is determined at 25° C. in a suitable solvent (M. Hoffmann, H. Krömer, R. Kuhn, Polymeranalytik I und II, Georg Thieme-Verlag, Stuttgart 1977).

The mean particle size d₅₀ is that diameter, above and below which 50 wt. % of the particles are distributed. It may be determined by means of ultracentrifuge measurement.(W. Scholtan, H. Lange, Kolloid-Z und Z. Polymere 250 (1972), 782-796).

Component B may, if required and if the rubber properties of component B.2 are not impaired thereby, additionally contain small amounts, ordinarily less than 5 wt. %, preferably less than 2 wt. %, relative to B.2, ethylenically unsaturated monomers having a crosslinking effect. Examples of such monomers having a crosslinking effect are esters of unsaturated monocarboxylic acids with 3 to 8 C atoms and of unsaturated monohydric alcohols with 3 to 12 C atoms, or of saturated polyols with 2 to 4 OH groups and 2 to 20 C atoms, polyunsaturated heterocyclic compounds, polyfunctional vinyl compounds such as alkylenediol di(meth)acrylates, polyester di(meth)acrylates, divinylbenzene, trivinylbenzene, trivinyl cyanurate, triallyl cyanurate, allyl (meth)acrylate, diallyl maleate diallyl fumarate, triallyl phosphate and diallyl phthalate.

Preferred crosslinking monomers are allyl methacrylate, ethylene glycol dimethacrylate, diallyl phthalate and heterocyclic compounds that have at least three ethylenically unsaturated groups.

In the case of preparation by means of bulk or solution or bulk-suspension polymerisation, the rubber-modified graft polymer B is obtained by graft polymerisation of 50 to 99, preferably 65 to 98, particularly preferably 75 to 97 parts by weight of a mixture consisting of 50 to 99, preferably 60 to 95 parts by weight monomers according to B.1.1 and 1 to 50, preferably 5 to 40 parts by weight monomers according to B.1.2 in the presence of 1 to 50, preferably 2 to 35, particularly preferably 2 to 15, in particular 2 to 13 parts by weight of the rubber component B.2.

The mean particle diameter d₅₀ of the grafted rubber particles generally exhibits values from 0.05 μm to 10 μm, preferably 0.1 μm to 5 μm, particularly preferably 0.2 μm to 1 μm.

The mean particle diameter d₅₀ of the resulting grafted rubber particles, which are obtainable by bulk or solution or bulk-suspension polymerisation processes (ascertained by enumeration in respect of electron micrographs) generally lies within the range from 0.5 μm to 5 μm, preferably from 0.8 μm to 2.5 μm.

The graft copolymers may be contained in component B singly or as arbitrary mixture with one another.

Component B is preferably contained in the polymer composition according to the invention in a quantity from 0.5 to 50 parts by weight, particularly preferably from 1 to 40 parts by weight, and quite particularly preferably from 1 to 35 parts by weight.

Component C

Mineral particles that are suitable in accordance with the invention are inorganic materials having imbricated or lamellar character, such as talc, mica/clay-bank minerals, montmorillonite, the latter also in an organophilic form modified by ion exchange, furthermore kaolin, vermiculite and wollastonite.

Talc and wollastonite are particularly preferred.

The term ‘talc’ is understood to mean a naturally occurring or synthetically produced talc. Pure talc has the chemical composition 3MgO.4SiO₂.H₂O and consequently an MgO content of 31.9 wt. %, an SiO₂ content of 63.4 wt. % and a content of chemically bound water of 4.8 wt. %. Talc is a silicate with layered structure.

Particularly preferred are talc types of high purity. The latter contain, for example, an MgO content from 28 to 35 wt. %, preferably 30 to 33 wt. %, particularly preferably 30.5 to 32 wt. % and an SiO₂ content from 55 to 65 wt. %, preferably 58 to 64 wt. %, particularly preferably 60 to 62.5 wt. %. Preferred talc types are distinguished furthermore by an Al₂O₃ content of <5 wt. %, particularly preferably <1 wt. %, in particular <0.7 wt. %.

Preferred mineral particles are, furthermore, also those with anisotropic particle geometry. This is understood to mean those particles, the so-called aspect ratio of which—the ratio of the largest and smallest particle diameters—is greater than 1, preferably greater than 2 and particularly preferably greater than about 5. Such particles are, at least in the broadest sense, lamellar or fibriform. Such materials include, for example, certain talcs and certain (alumino)silicates with stratified or fibrous geometry, such as bentonite, wollastonite, mica, kaolin, hydrotalcite, hectorite or montmorillonite.

Also advantageous, in particular, is the use of talc in the form of finely ground types with a mean particle size d₅₀ of <10 μm, preferably <5 μm, particularly preferably <2.5 μm, quite particularly preferably ≦1.5 μm. Preferred in particular is the use of talc with a mean particle size d₅₀ from 350 nm to 1.5 μm.

Preferred wollastonites have a mean aspect ratio of >6, in particular ≧7, and a mean fibre diameter from 1 μm to 15 μm, preferably 2 μm to 10 μm, in particular from 4 μm to 8 μm.

The mean aspect ratio in the sense of the invention is the ratio of the mean length of the fibre to the mean diameter.

Particle size and particle diameter in the sense of this invention signify the mean particle diameter d₅₀, ascertained by ultracentrifuge measurements according to W. Scholtan et al., Kolloid-Z. und Z. Polymere 250 (1972), pp 782-796.

Furthermore, the mineral particles may be surface-modified with organic molecules, for example silanised, in order to achieve a better compatibility with the polymers. In this way it is possible for hydrophobic or hydrophilic surfaces to be generated.

As described in U.S. Pat. No. 5,091,461, in particular elongated or plate-like materials having the specified small particles are suitable in comparison with fibrillar or spherical fillers. Highly preferred are those compositions which contain particles that have a ratio of average diameter to thickness (D/T), measured in accordance with the way described in U.S. Pat. No. 5,714,537, of at least 4, preferably at least 6, more preferably at least 7. With regard to the maximum value of the ratio D/T, it has been found desirable to have a value up to and including 30, preferably up to and including 24, more preferably up to and including 18, still more preferably up to and including 13, and most preferably up to and including 10.

The mineral particles may be present in the form of powders, pastes, sols, dispersions or suspensions. Powders may be obtained from dispersions, sols or suspensions by precipitation.

The materials may also be worked into the thermoplastic molding compositions in accordance with conventional processes, for example by direct kneading or extrusion of molding compositions and the ultrafine-particle inorganic powders. Preferred processes are constituted by the production of a master batch, for example in flameproofing additives, and at least one component of the molding compositions according to the invention in monomers or solvents, or the coprecipitation of one thermoplastic component and the ultrafine-particle inorganic powders, for example by coprecipitation of an aqueous emulsion and the ultrafine-particle inorganic powders, optionally in the form of dispersions, suspensions, pastes or sols of the ultrafine-particle inorganic materials.

Examples of substances that may be preferentially employed in accordance with the invention as mineral particles are Tremin® 939-300EST, produced by Quarzwerke GmbH, Frechen, Germany (aminosilane-coated wollastonite with a mean needle diameter of 3 μm), Finntalc® M30SL, produced by Omya GmbH, Cologne, Germany (uncoated talc with a particle size d₅₀=8.5 μm), Wicroll® 40PA, produced by Omya GmbH, Cologne, Germany (silanised wollastonite with a particle size d₅₀=1.3 μm) and also Burgess® 2211, produced by Omya GmbH, Cologne, Germany (aminosilane-coated aluminium silicate with a particle size d₅₀=1.3 μm), Naintsch A3 (see Examples, Component C1), Nyglos® 4-10013 (see Examples C2).

The mineral particles of component C may be contained in the composition according to the invention in a quantity of preferably up to 30 parts by weight, particularly preferably up to 20 parts by weight and, if included, preferably from 1.5 to 13 parts by weight.

Component D

By way of component D) the compositions may contain, in accordance with the invention, particulate carbon compounds such as carbon black, which is suitable for establishing conductivity and is also designated by those skilled in the art as conductivity carbon black, graphite powders and/or carbon nanofibrils.

In the case of graphite powders in the sense of the present invention, it is a question of comminuted graphite. A person skilled in the art understands graphite to be a modification of carbon, as described, for example, in A. F. Hollemann, E. Wieberg, N. Wieberg, Lehrbuch der anorganischen Chemie, 91st-100th Edn., pp 701-702. Graphite consists of planar carbon layers which are arranged above one another. According to the invention, graphite may, for example, be comminuted by grinding. The particle size lies within the range of up to 0.1 μm -1 mm, preferably within the range from 1 μm to 300 μm, most preferably within the range from 2 μm to 20 μm.

In the case of conductivity carbon blacks according to the invention, the primary-particle size lies between 0.005 μm and 0.2 μm, preferably between 0.01 μm and 0.1 μm. The dibutyl-phthalate adsorption of the conductivity carbon blacks lies between 40 ml and 1000 ml per 100 g carbon black, preferably between 90 ml and 600 ml per 100 g carbon black. A large number of oxygen-bearing groups, such as, for example, carboxyl, lactol, phenol groups, quinoid carbonyl groups and/or pyrone structures, may be located on the surface of the carbon black.

Conductivity carbon blacks may, for example, be produced from acetylene, from synthesis gas or from the furnace process from oil, carrier gases and air. Production processes are described, for example, in R. G. Gilg, Ruβ für leitfähige Kunststoffe in: Elektrisch leitende Kunststoffe, Editors: H. J. Mair, S. Roth, 2^{nd} edition, Carl Hanser Verlag, 1989, Munich, Vienna, pp 21-36 and in the literature cited therein.

Addition of the carbon blacks and/or graphites according to the invention may be effected before, during or after the polymerisation of the monomers to form the thermoplastic of component A). If addition of the carbon blacks and/or graphites according to the invention is effected after the polymerisation, it is preferably effected by addition to the thermoplastic melt in an extruder or in a kneader. According to the invention, the carbon blacks and/or graphites may also be added in metered amounts in the form of highly concentrated master batches in thermoplastics which are preferably chosen from the group comprising the thermoplastics employed as component A). The concentration of the carbon blacks and/or graphites in the master batches lies within the range from 5 to 70, preferably 8 to 50, particularly preferably within the range from 12 to 30 wt. % (relative to the master batch). In accordance with the invention, the carbon blacks and/or graphites may, for the purpose of better meterability, also be added to binding agents such as, for example, waxes, fatty-acid esters or polyolefins. In accordance with the invention, the carbon blacks and/or graphites may also be pelletised or granulated with or without additional binding agents, for example by press-molding or compression processes, which likewise serves for better meterability.

Carbon nanofibrils according to the invention typically have the form of tubes which are formed from layers of graphite. The graphite layers are disposed around the axis of the cylinder in concentric manner.

Carbon nanofibrils have a length-to-diameter ratio of at least 5, preferably at least 100, particularly preferably at least 1000. The diameter of the nanofibrils typically lies within the range from 0.003 μm to 0.5 μm, preferably within the range from 0.005 μm to 0.08 μm, particularly preferably within the range from 0.006 μm to 0.05 μm. The length of the carbon nanofibrils typically amounts to 0.5 μm to 1000 μm, preferably 0.8 μm to 100 μm, particularly preferably 1 μm to 10 μm. The carbon nanofibrils possess a hollow, cylindrical core, around which the graphite layers are formally wound. This hollow space typically has a diameter from 0.001 μm to 0.1 μm, preferably a diameter from 0.008 μm to 0.015 μm. In a typical embodiment of the carbon nanofibrils the wall of the fibril around the hollow space consists, for example, of eight graphite layers. The carbon nanofibrils may in this case be present in the form of aggregates with a diameter up to 1000 μm, preferably with a diameter up to 500 μm, consisting of several nanofibrils. The aggregates may have the form of birds' nests, of combed yarn or of open net structures.

Addition of the carbon nanofibrils may be effected before, during or after the polymerisation of the monomers to form the thermoplastic of component A). If addition of the carbon nanofibrils according to the invention is effected after the polymerisation, it is preferably effected by addition to the thermoplastic melt in an extruder or in a kneader. As a result of the compounding process in the kneader or extruder, in particular the aggregates already described may be largely or even totally comminuted and the carbon nanofibrils may be dispersed in the thermoplastic matrix.

In a preferred embodiment the carbon nanofibrils may be added in metered amounts in the form of highly concentrated master batches in thermoplastics which are preferably chosen from the group comprising the thermoplastics employed as component A). The concentration of the carbon nanofibrils in the master batches lies within the range from 5 to 50, preferably 8 to 30, particularly preferably within the range from 12 to 22 wt. %. The production of master batches is described in U.S. Pat. No. 5,643,502, for example. Through the use of master batches, in particular the comminution of the aggregates may be improved. Due to the processing to form the molding composition or molded article, the carbon nanofibrils may exhibit shorter length distributions in the molding composition or in the molded article than originally employed.

In a preferred embodiment, use may also be made of mixtures of the individual components.

Conductivity carbon blacks according to the invention may, for example, be procured under the name Ketjenblack® from AKZO Nobel, under the name Vulcan® from Cabot or under the name Printex® from Degussa.

Graphites according to the invention may be procured in the form of powders, for example from Vogel & Prenner Nachf., Wiesbaden, Germany.

Carbon nanofibrils are offered for sale, for example, by Hyperion Catalysis or by Applied Sciences Inc. Synthesis of the carbon nanofibrils is effected, for example, in a reactor that contains a carbon-containing gas and a metal catalyst, as described in U.S. Pat. No. 5,643,502, for example.

Component E

Preferred polyester/ether block copolymers contain the reaction product of ethylene glycol, terephthalic acid or dimethyl terephthalate and polyethylene glycol. Polyester/ether copolymers are described, for example, in Encyclopedia of Polymer Science and Engineering, Vol. 12, John Wiley & Sons, Inc., N.Y., 1988, pages 49-52.

Preferred polyether ester amides are block copolymers in which the polyether segments are polyethylene-glycol units with a molecular weight Mₙ from 200 to 6000 Dalton and the polyamide segments exhibit a molecular weight Mₙ generally from 200 to 6000 Dalton. The block copolymer preferably contains 4 to 14 polyamide segments. Suitable polyether ester amides are described in EP-A 613 919, for example. The polyamides that were named in the description of component A) enter into consideration by way of polyamide segments.

The polymers according to component E) are preferably employed in the form of antistatic preparations which, for example, may additionally contain inorganic or organic salts. Such antistatic preparations or antistatic agents are described, inter alia, in WO 02/055411 and U.S. Pat. No. 5,965,206 and also in the references cited therein.

WO 02/055411 and U.S. Pat. No. 5,965,206 are incorporated herein by reference.

Such antistatic compositions are, for example, commercially obtainable from the Ciba Specialty Chemicals Company under the names Irgastat® P18 and Irgastat® P22.

Antistatic mixtures or preparations preferably contain inorganic salts selected from the group consisting of LiClO₄, LiCF₃SO₃, NaClO₄, LiBF₄, NaBF₄, KBF₄, NaCF₃SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF₆)₂ or Ca(CF₃SO₃)₂, which are generally present in complexed or solvated form in the polyether ester amide, polyether/ester block copolymer or polyamide/polyether block copolymer or mixtures of these substances.

Suitable organic salts are preferably selected from organic salts of zinc, barium, cadmium, aluminium, calcium, magnesium or a rare-earth metal with aliphatic saturated C₂-C₂₂ carboxylates, aliphatic unsaturated C₃-C₂₂ carboxylates, aliphatic C₂-C₂₂ carboxylates which are substituted by at least one hydroxyl group or which have a chain interrupted by at least one oxygen atom, furthermore cyclic or bicyclic C₅-C₂₂ carboxylates, in each case unsubstituted or substituted by at least one OH group and/or C₁-C₁₆ alkyl, phenyl carboxylate, phenyl C₁-C₁₆ alkyl carboxylate, naphthyl C₁-C₁₆ alkyl carboxylate, or unsubstituted phenolate or phenolate substituted by C₁-C₁₂ alkyl. Mixtures of these salts are likewise suitable.

Particularly preferred antistatic preparations are mixtures containing

1. an organic fibriform or fibre-forming polymer such as polyamide, copolyamide, polyester, polyvinyl acetate, polyvinyl alcohol, polyacrylic ester, modified cellulose, and furthermore those which are listed in U.S. Pat. No. 5,965,206, column 6, lines 10 to 17. Polyester, polyamide 46, polyamide 66, polyamide 6 or copolyamide 6/66 is preferably employed by way of fibriform material;

2. the copolymers named as component E) and

3. aforementioned organic or inorganic salts or mixtures thereof.

Component F

Thermoplastic polymers with polar groups are preferably employed by way of compatibility promoter.

Suitable compatibility promoters include polymers that, are polymerized from

F.1 a vinyl aromatic monomer,

F.2 at least one monomer selected from the group comprising C₂ to C₁₂ alkyl methacrylates, C₂ to C₁₂ alkyl acrylates, methacrylonitriles and acrylonitriles and

F.3 α,β-unsaturated components containing dicarboxylic anhydrides.

Styrene is particularly preferred by way of vinyl aromatic monomer F.1.

Acrylonitrile is particularly preferred for component F.2.

Maleic anhydride is particularly preferred for α,β-unsaturated components containing dicarboxylic anhydrides F.3.

Terpolymers of the stated monomers are preferably employed by way of components F.1, F.2 and F.3. Accordingly, terpolymers of styrene, acrylonitrile and maleic anhydride preferably find application. These terpolymers contribute, in particular, to improving the mechanical properties such as tensile strength and elongation at rupture. The quantity of maleic anhydride in the terpolymer may fluctuate within wide limits. The quantity preferably amounts to 0.2 to 5 mol %. Particularly preferred are quantities between 0.5 and 1.5 mol %. Within this range particularly good mechanical properties are achieved with respect to tensile strength and elongation at rupture.

The terpolymer may be prepared in a manner known as such. A suitable method is the dissolution of monomer components of the terpolymer, for example of the styrene, maleic anhydride or acryonitrile, in a suitable solvent, for example methyl ethyl ketone (MEK). To this solution there are added one or, optionally, more chemical initiators. Suitable initiators are, for example, peroxides. Then the mixture is polymerised for several hours at elevated temperatures. Subsequently the solvent and the unreacted monomers are removed in a manner known as such.

The ratio of component F.1 (vinyl aromatic monomer) to component F.2, for example the acrylonitrile monomer, in the terpolymer is preferably-between 80:20 and 50:50. In order to improve the miscibility of the terpolymer with the graft copolymer B, a quantity of vinyl aromatic monomer F.1 is preferably selected that corresponds to the quantity of the vinyl monomer B.1 in the graft copolymer B.

Examples of compatibility promoters F that may be employed in accordance with the invention are described in EP-A 785 234 and EP-A 202 214. Preferred in accordance with the invention are, in particular, the polymers named in EP-A 785 234.

The compatibility promoters may be contained in component F singly or in arbitrary mixture with one another.

Another substance which is particularly preferred by way of compatibility promoter is a terpolymer of styrene and acrylonitrile in a weight ratio 2.1:1 containing 1 mol % maleic anhydride.

The quantity of component F in the polymer compositions according to the invention preferably lies between 0.5 and 30 parts by weight, in particular between 1 and 20 parts by weight and, particularly preferably, between 2 and 10 parts by weight. Most highly preferred are quantities between 3 and 7 parts by weight.

Component G

Component G comprises one or more thermoplastic vinyl (co)polymers.

Suitable vinyl (co)polymers for component G are polymers of at least one monomer from the group comprising the vinyl aromatics, vinyl cyanides (unsaturated nitrites), (meth)acrylic (C₁-C₈) alkyl esters, unsaturated carboxylic acids and also derivatives (such as anhydrides and imides) of unsaturated carboxylic acids. Particularly suitable are (co)polymers formed from

G.1 50 to 99, preferably 60 to 80 parts by weight vinyl aromatics and/or ring-substituted vinyl aromatics (such as styrene, α-methylstyrene, p-methylstyrene, p-chlorostyrene) and/or methacrylic (C₁-C₈) alkyl esters (such as methyl methacrylate, ethyl methacrylate), and

G.2 1 to 50, preferably 20 to 40 parts by weight vinyl cyanides (unsaturated nitriles) such as acrylonitrile and methacrylonitrile and/or (meth)acrylic (C₁-C₈) alkyl esters (such as methyl methacrylate), n-butyl acrylate, tert-butyl acrylate) and/or imides of unsaturated carboxylic acids (e.g. N-phenylmaleimide).

The (co)polymers G are resinous, thermoplastic and rubber-free.

Particularly preferred is the copolymer formed from G.1 styrene and G.2 acrylonitrile.

The (co)polymers G are known and may be prepared by radical polymerisation, in particular by emulsion, suspension, solution or bulk polymerisation. The (co)polymers preferably possess mean molecular weights Mw (weight average, ascertained by light scattering or sedimentation) between 15,000 and 200,000.

The vinyl (co)polymers may be contained in component G on their own or in arbitrary mixture with one another.

Component G is preferably contained in the polymer composition in a quantity from 0 to 30 parts by weight, in particular from 0 to 25 parts by weight and, particularly preferably, from 0 to 20 parts by weight, in particular 0.5 to 10 parts by weight.

Component H

Phenolformaldehyde resins according to the invention are prepared by condensation reaction of phenols with aldehydes, preferably formaldehyde, by derivatisation of the condensates resulting thereby, or by addition of phenols to unsaturated compounds, such as, for example, acetylene, terpenes etc.

Condensation may be effected in this connection in the acidic or basic range, and the molar ratio of aldehyde to phenol may amount to from 1:0.4 to 1:2.0. In this case oligomers or polymers with a molar mass from 150 to 5000 g/mol arise. The resins are known or may be prepared by processes known from the literature.

The compositions preferably contain phenolformaldehyde resins, which are generally added in a quantity of up to 15 parts by weight, preferably 1 to 12 and, in particular, 2 to 8 parts by weight.

Component J

The polymer compositions according to the invention may contain conventional additives, such as flameproofing agents, anti-dripping agents, filling and reinforcing materials, different from components C and D, lubricants and mold-release agents, nucleating agents, anti-static agents, different from component E, stabilisers as well as dyestuffs and pigments.

The compositions according to the invention may generally contain 0.01 to 20 parts by weight, relative to the overall composition, flameproofing agents. Named in exemplary manner by way of flameproofing agents are organic halogen compounds such as decabromobisphenyl ether, tetrabromobisphenol, inorganic halogen compounds such as ammonium bromide, nitrogen compounds such as melamine, melamineformaldehyde resins, inorganic hydroxide compounds such as Mg—Al hydroxide, inorganic compounds such as aluminium oxides, titanium dioxides, antimony oxides, barium metaborate, hexahydroxoantimonate, zirconium oxide, zirconium hydroxide, molybdenum oxide, ammonium molybdate, tin borate, ammonium borate and tin oxide as well as siloxane compounds.

By way of flameproofing compounds, furthermore phosphorus compounds as described in EP-A 363 608, EP-A 345 522 and/or EP-A 640 655 may be employed.

By way of further filling and reinforcing materials, glass fibres, optionally cut or ground, glass beads and glass bulbs enter into consideration, for example.

All data relating to parts by weight in this application should be normalised in such a way that the sum of the parts by weight of all the components is set equal to 100.

The compositions according to the invention are prepared by the respective constituents being mixed in known manner and being melt-compounded and melt-extruded at temperatures from 200° C. to 300° C. in conventional units such as internal kneaders, extruders and twin-rotor screws, the mold-release agent being employed in the form of a coagulated mixture.

Mixing of the individual constituents may be effected in known manner both successively and simultaneously, both at about 20° C. (room temperature) and at higher temperature.

The polymer compositions according to the invention may be used for producing moldings of any type. In particular, moldings may be produced by injection molding. Examples of moldings are: casing parts of any type, for example for household appliances such as electric shavers, flatscreens, monitors, printers, copiers, or cover plates for the construction industry, and parts for motor vehicles and rail vehicles. In addition, they may be employed in the field of electrical engineering, because they have very good electrical properties.

Moreover, the polymer compositions according to the invention may, for example, be used for the purpose of producing the following moldings:

Interior finishing parts for rail vehicles, ships, buses, other motor vehicles and aircraft, wheel caps, casings of electrical equipment containing small transformers, casings for instruments for the dissemination and transmission of information, planar wall elements, casings for security devices, rear spoilers and other bodywork parts for motor vehicles, thermally insulated transit containers, devices for keeping or taking care of small animals, cover grilles for ventilator openings, moldings for summerhouses and tool sheds, casings for gardening implements.

Another form of processing is the production of moldings from previously produced sheets or films by thermoforming.

The present invention therefore further provides also the use of the compositions according to the invention for the production of moldings of any type, preferably the aforementioned, as well as the moldings consisting of the compositions according to the invention.

By reason of the excellent online lacquerability, the present invention likewise provides the online-lacquered moldings, preferably online-lacquered exterior parts for motor vehicles, for example wheel housings, wings, exterior mirror housings etc.

The following Examples serve for further elucidation of the invention.

### EXAMPLES

In accordance with the data of Table 1, the compositions are produced, processed further into test pieces and tested.

Component A1

Polyamide 66 (Ultramid® A3, BASF, Ludwigshafen).

Component A2

Noryl® GTX974, General Electric Plastics, Bergen op Zoomen, Netherlands.

Component B

Graft polymer of 40 parts by weight of a copolymer formed from styrene and acrylonitrile in a ratio of 73:27 onto 60 parts by weight of polybutadiene rubber crosslinked in particulate manner (mean particle diameter d₅₀=0.28 μm), produced by emulsion polymerisation.

Component C1

Naintsch A3 (Naintsch Mineralwerke GmbH, Graz, Austria). Talc with a mean particle diameter (d₅₀), according to the manufacturer's data, of 1.2 μm.

Component C2

Nyglos® 4-10013 (silanised wollastonite with a particle size, according to the manufacturer's data, of 4.8 μm) NYCO Minerals Inc., N.Y. USA.

Component D

Ketjenblack® EC 600 (Akzo Nobel, Verkaufsbüro Düren, 52349 Düren, Germany) (electrically conductive carbon black).

Component E

Irgastat® P22, Ciba Speciality Chemicals, Switzerland.

Component F

Terpolymer of styrene and acrylonitrile with a weight ratio of 2.1:1 containing 1 mol % maleic anhydride.

Component G

Styrene/acrylonitrile copolymer with a styrene/acrylonitrile weight ratio of 72:28 and with an intrinsic viscosity of 0.55 dl/g (measurement in dimethylformamide at 20° C.).

Component H

Rhenosin® RB (phenolformaldehyde resin), Rhein Chemie Rheinau GmbH, Mannheim.

Component J

For additives, see Table 1.

Production and Testing of the Molding Compositions According to the Invention

Mixing of the components of the compositions is effected using a 31 internal kneader. The molded articles are produced in an injection-molding machine of type Arburg 270E at 280° C.

Determination of the Vicat B thermostability is effected in accordance with ISO 306 in respect of rods having dimensions 80×10×4 mm.

The impact strength aₙ is determined in accordance with ISO 180/1.

The MVR (Melt Volume Rate) is determined in accordance with ISO 1133 at 280° C. by using a ram load of 5 kg.

The surface resistivity is determined in accordance with DIN IEC 60167.

The elongation at rupture is determined in the tensile test according to ISO 527.

The results of the individual tests are summarised in Table 1.

TABLE 1
Composition and properties (data in parts by weight)

| | | 1 | 2 | 3 | Comparison 1 | Comparison 2 |
|---|---|---|---|---|---|---|
| Example/ | | | | | | |
| Components | | | | | | |
| A1 | Polyamide 66 | 57.47 | 55.15 | 56.77 | 57.65 | 59.32 |
| B | Graft polymer | 17.49 | 17.14 | 17.29 | 17.11 | 18.61 |
| C1 | Talc | 7.32 | 8.07 | | 7.79 | 7.79 |
| C2 | Wollastonite | — | — | 8.35 | — | — |
| D | Carbon black | 1.32 | | 1.39 | 5 | 1.84 |
| E | Antistatic additive | 4.70 | 9.09 | 4.64 | — | — |
| F | Compatibility | 4.51 | 4.19 | 4.46 | 4.8 | 4.8 |
| | promoter | | | | | |
| G | Styrene/acrylonitrile | 2.48 | 1.79 | 2.45 | 2.64 | 2.64 |
| | copolymer | | | | | |
| H | Phenolformaldehyde | 3.23 | 3.22 | 3.20 | 3.45 | 3.45 |
| | resin | | | | | |
| J1 | Mold-release | 0.24 | 0.22 | 0.22 | 0.24 | 0.24 |
| | agent | | | | | |
| J2 | Stabilisers | 1.24 | 1.32 | 1.23 | 1.32 | 1.32 |
| Properties | | | | | | |
| Elongation at | % | 15.2 | 19.5 | 15.2 | 11.3 | 18.7 |
| rupture | | | | | | |
| aₙ (RT) | KJ/m² | 64.4 | 69.3 | 66.2 | 44.3 | 56.8 |
| (−30° C.) | KJ/m² | 47 | 54.2 | 44.5 | 31.6 | 29.2 |
| Surface resistivity | Ω | 2.9E+11 | 3.9E+11 | 1.8E+12 | 2.8E+5 | 1.1E+16 |
| MVR | cm³/(10 min) | 13 | 14 | 14 | n.m.¹⁾ | 1.2 |
| Vicat B | ° C. | 156 | 152 | 153 | 158 | 156 |

¹⁾n.m.: not measurable

The use of component E shows positive properties with regard to the toughness of the molding composition and also the flow behaviour. In Example 1 the combination of E and D has a positive effect. Although a very good surface resistivity is obtained with the use of quantities of carbon black (Comparative Example 1), comparable to component E in Example 1, the MVR value falls so considerably that it may no longer be determined under the given conditions. With the use of less carbon black (Comparative Example 2) the surface resistivity is very high and, in addition, the MVR value is clearly lower in contrast with Examples 1 and 2 according to the invention.

The advantageous properties as in Example 1 also show up with wollastonite as filler (Example 3).

The value of the surface resistivity in Examples 1, 2 and 3 is sufficient for an electrostatic lacquering of a molding without previous treatment with a conductive primer.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic molding composition comprising
A) 40 to 99 parts by weight polyamide,
B) 0.5 to 50 parts by weight graft polymer,
C) 0.1 to 30 parts by weight mineral in particulate form,
D) 0 to 1.5 parts by weight electrically conductive carbon particles,
E) 0.1 to 15 parts by weight of at least one member selected from the group consisting of polyester ether amide, polyester/ether block copolymer and polyamide/polyester block copolymer,
the sum of the parts by weight of components A) through E) totalling 100.

2. The composition according to claim 1 further comprising at least one member selected from the group consisting of compatibility promoter, rubber-free vinyl (co)polymer, phenolformaldehyde resin and polymer additive.

3. The composition according to claim 2 wherein the polyamide is present in an amount of 50 to 85 parts by weight, the graft polymer is present in an amount of 1 to 30 parts by weight, the mineral particles are present in an amount of 1 to 20 parts by weight, and at least one member is present in an amount of 1 to 12 parts by weight.

4. The composition according to claim 1 further containing up to 30 parts by weight of at least one rubber-free vinyl (co)copolymer formed from F.1) a vinyl aromatic monomer, F.2) at least one monomer selected from the group comprising C₂ to C₁₂ alkyl methacrylates, C₂ to C₁₂ alkyl acrylates, acrylonitriles and methacrylonitriles and F.3) α,β-unsaturated components containing dicarboxylic anhydrides.

5. The composition according to claim 1 wherein the graft polymer contains a grafted phase polymerized from
B.1.1) at least one member selected from the group consisting of styrene, α methylstyrene, halogen-substituted or alkyl-ring-substituted styrenes, (meth)acrylic C₁-C₈ alkyl esters, and
B.1.2) at least one member selected from the group consisting of unsaturated nitrites, (meth)acrylic C₁-C₈ alkyl esters and derivatives of unsaturated carboxylic acids, and
a graft base having glass transition temperature ≦10° C.

6. The composition according to claim 5 wherein the graft base is at least one member selected from the group consisting of diene rubber, copolymer of diene rubber, acrylate rubber, polyurethane/silicone rubber, chloroprene rubber and ethylene/vinyl-acetate rubber.

7. The composition according to claim 5 wherein the graft base is at least one member selected from the group consisting of diene rubbers, copolymer of diene rubber and acrylate rubber.

8. The composition according to claim 7 wherein the graft base is polybutadiene.

9. The composition according to claim 1 wherein the electrically conductive carbon is at least one member selected from the group consisting of carbon blacks, graphites and carbon nanofibrils.

10. The composition according to claim 1 wherein the mineral is at least one member selected from the group consisting of talc, mica, clay-bank minerals, montmorillonite, kaolin, vermiculite and wollastonite.

11. The composition according to claim 10 wherein the member is at least one member selected from the group consisting of talc and wollastonite.

12. The composition according to claim 2 wherein the member is phenolformaldehyde resin present in an amount of 1 to 12 parts by weight.

13. A molded article comprising the composition according to claim 1.
